(19) United States
(12) Patent Application Publication
(10) Pub. No.: US 2022/0281753 A1
(43) Pub. Date: Sep. 8, 2022

(54) METHOD FOR SEQUESTERING CARBON

(71) Applicant: PETROLIAM NASIONAL BERHAD (PETRONAS), Kuala Lumpur (MY)

(72) Inventors: Mohammad Ghaddaffi b M NOH, Kuala Lumpur (MY); M Syazwan B ONN, Kuala Lumpur (MY); Ruzilah Binti SANOM, Kuala Lumpur (MY)

(73) Assignee: PETROLIAM NASIONAL BERHAD (PETRONAS), Kuala Lumpur (MY)

(21) Appl. No.: 17/638,814

(22) PCT Filed: Aug. 26, 2019
(86) PCT No.: PCT/MY2019/050048

§ 371 Date: Feb. 26, 2022

(51) Int. Cl. C01F 11/18; B01D 53/62; B01D 53/80

(52) U.S. Cl. CPC C01F 11/181; B01D 53/62; B01D 53/80; B01D 2251/404; B01D 2257/504

(57) ABSTRACT

A method for sequestering carbon by spraying an aqueous solution containing calcium ions into a reactor containing supercritical carbon dioxide to form a slurry of calcium carbonate, and collecting the calcium carbonate from the bottom of the reactor.

### FIELD OF INVENTION

The invention relates to a method for sequestering carbon, in particular by mineral carbonation of supercritical carbon dioxide.

### BACKGROUND

Carbon dioxide emissions due to the burning of fossil fuels is one of the leading sources of global warming. Therefore reducing the amount of carbon dioxide released into the atmosphere through carbon sequestration can help with this problem.

A conventional method for sequestering carbon is the process of mineral carbonation, the most common of which is where carbon dioxide gas is bubbled through an aqueous solution of calcium hydroxide in a reactor to form solid particles of calcium carbonate, a reaction which can be represented as follows:

Ca(OH)₂+CO₂→CaCO₃+H₂O

However, there are several issues with the conventional method. Typically the rate of carbon dioxide dissolution is the rate determining step, and is relatively slow such that it often takes a long time to produce calcium carbonate for a given amount of calcium hydroxide. The interfacial interface between gas and liquid is a limiting factor, and in order to maximise the same, large tanks are required for the reaction to take place. Furthermore, the method is inefficient as calcium carbonate has to be regularly removed from the bottom of the reactor causing downtime, and perhaps only 10% of the carbon dioxide is consumed per batch—most of the remainder is recycled (which requires a large compressor) but some is lost in the process.

An aim of the invention therefore is to provide a method for sequestering carbon which overcomes the above issues.

### SUMMARY OF INVENTION

In an aspect of the invention, there is provided a method for sequestering carbon comprising the steps of:
spraying a solution containing calcium ions into a reactor containing supercritical carbon dioxide to form a slurry of calcium carbonate;
collecting the calcium carbonate from the bottom of the reactor.

Advantageously calcium carbonate is formed almost instantly as a precipitate when the solution of calcium ions is sprayed into the supercritical carbon dioxide and accordingly the rate-limiting step of the prior art is minimised. This is because the supercritical state of the carbon dioxide allows the interfacial surface area with the calcium solution to be significantly increased, and the spray of fine droplets increases the contact area of the carbon dioxide to dissolve and react with calcium ions. As a result, the reactor footprint can be reduced by up to 50 times or more.

In one embodiment the solution is prepared by mixing calcium oxide with water. Typically the solution comprises aqueous calcium hydroxide. In one embodiment the solution comprises undissolved calcium oxide.

In one embodiment the supercritical carbon dioxide is provided in excess for the reaction with the calcium solution.

In one embodiment the calcium carbonate formed by the reaction drops to bottom of the reactor to forms the slurry.

In one embodiment the top section of the reactor is provided with an injector nozzle, typically with a working pressure of around 80 bar to around 400 bar. The injector nozzle is used to spray the calcium hydroxide

In one embodiment the bottom section of the reactor is provided with an outlet with a back pressure regulator.

In one embodiment the regulator is adjusted such that the slurry continuously flows out of the reactor via the outlet while maintaining a predetermined height of slurry within the reactor.

In one embodiment the slurry column height is about 10% of the reactor height. However, it will be appreciated that the slurry column height may be adjusted by adjusting the back pressure regulator setting, to provide varying liquid retention time in the reactor. The increase of backpressure regulator opening pressure will proportionately increase the slurry column height, thus increasing the slurry liquid retention time. By varying the slurry retention time at the bottom of the reactor, the average particle size distribution of the precipitated calcium carbonate crystals may be varied accordingly

Advantageously the slurry forms a barrier to prevent supercritical carbon dioxide from leaking from the reactor. In addition, the continuous flow ensures that any shut down time is minimised.

In one embodiment the flow rate of the calcium solution is adjustable and inversely proportional to the particle size. Typically the flow rate is 1 L/min and the particle size is around 3-7 μm, preferably about 5 μm.

Other parameters that can affect the particle size include reactor working pressure, flow rate of the calcium solution, retention time of the slurry, recycling of calcium solution, and contaminants such as methane.

In a further aspect of the invention there is provided a reactor for sequestering carbon comprising:
means for introducing supercritical carbon dioxide into a reaction chamber within the reactor;
an injector nozzle for spraying a solution containing calcium ions into the reaction chamber; and
an outlet with a back pressure regulator at the bottom of the reaction chamber;
wherein the regulator is adjustable such that a slurry can continuously flow out of the reactor via the outlet while maintaining a predetermined height of slurry within the reactor.

In a further aspect of the invention there is provided calcium carbonate made according to the method herein described.

### BRIEF DESCRIPTION OF DRAWINGS

It will be convenient to further describe the present invention with respect to the accompanying drawings that illustrate possible arrangements of the invention. Other arrangements of the invention are possible, and consequently the particularity of the accompanying drawings is not to be understood as superseding the generality of the preceding description of the invention.

FIG. 1 is a block diagram of the overall system for making calcium carbonate according to an embodiment of the invention.

FIG. 2 is a schematic diagram of the reactor according to an embodiment of the invention.

FIG. 3 is a schematic diagram of a conventional reactor according to the prior art.

### DETAILED DESCRIPTION

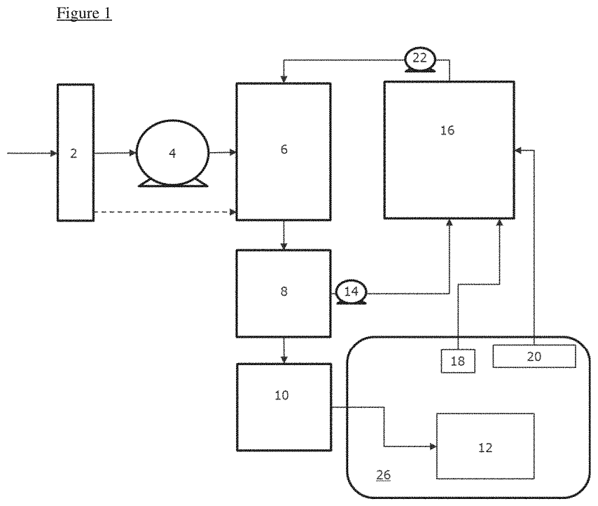

With regard to FIG. 1, cool carbon dioxide (50 bar, 10° C.) enters a chamber 2 where it undergoes isochoric expansion (80-200 bar, 30° C.), after which it is pumped by a low compression ratio pump 4 into the reactor 6 in a supercritical condition (80 bar, 30° C.). It is also possible to provide supercritical carbon dioxide from gaseous phase carbon dioxide permeate.

An aqueous solution containing calcium ions such as calcium hydroxide is sprayed into the supercritical carbon dioxide in the reactor to precipitate calcium carbonate. The resulting slurry exits the reactor 6 via an outlet at the bottom, and liquids are separated from solids using a centrifuge 8. The wet precipitated calcium carbonate is then heated/dried 10 and once dry bagged 12 in a storage facility 26.

The spent liquid is directed to a reactivation vessel 16 using pump 14, where calcium oxide from hopper 18 is mixed with deionised water from tank 20 to form calcium hydroxide. The charged liquid is directed to the top of the reactor via pump 22

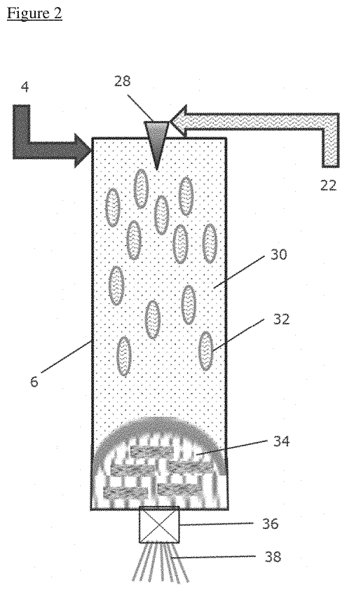

With reference to FIG. 2, the reactor 6 is shown in more detail. Calcium hydroxide is injected in the form of atomised droplets via nozzle 28 into excess supercritical carbon dioxide 30, where it precipitates as calcium carbonate 32 almost instantaneously. The calcium carbonate falls to the bottom of the reactor 6 and forms a slurry 34 which builds up and prevents egress of carbon dioxide through the regulator 36. However, as the injection of calcium hydroxide increases the reactor pressure, the slurry is eventually forced out of the reactor 6 via the regulator 36, which can be adjusted to suit the pressure and slurry flow i.e. while maintaining a sufficient height of slurry to substantially prevent the carbon dioxide from escaping. For example, in a cylindrical reactor 10 m high and 2 m in diameter, a slurry height of around 1.5 m may be maintained to prevent escape of carbon dioxide through the regulator. The wet precipitate 38 can then be processed further without having to disrupt the continuous flow operation of the reactor.

To clean the regulator of scale or other deposits which may build up over time, a simple acid backwash can be used. The downtime for the reactor is perhaps only a few hours in a month, rather than the regular downtime required for the conventional batch operation reactors.

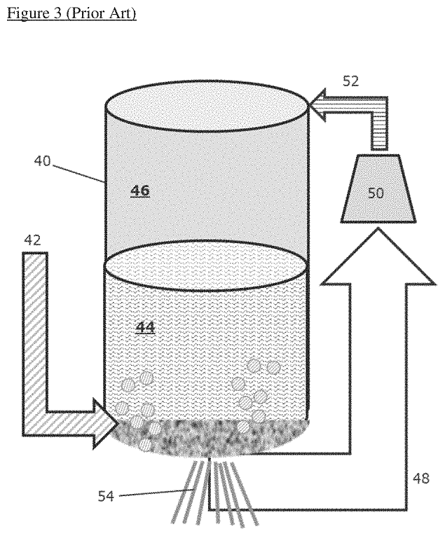

With regard to FIG. 3, a conventional process is illustrated for comparison. Carbon dioxide gas is fed 42 into the bottom of a large reactor 40 where it is bubble through a solution of calcium hydroxide 44, under atmospheric pressure carbon dioxide 46. However, typically less than 10% of the carbon dioxide gas is consumed as it is bubbled, so the process is inefficient by comparison to the invention. The precipitated calcium carbonate 54 falls to the bottom of the reactor 40, and has to be removed in batches. The reactor is offline during this removal period. Carbon dioxide escaping from the bottom is directed 48 to a scrubber 50 and then directed 52 to the top of the reactor 40, but much is lost as a result.

For comparison, a conventional process typically takes 20 minutes to produce 75 g of calcium carbonate for 5 L calcium hydroxide. However, according to the invention, 17.85 g/min CaCO₃ is produced for 10 g CaO/min injected, hence 85 g CaCO₃ is produced with 5 L solvent injected into reactor in only 5 minutes. Therefore the invention produces more carbonate from the solvent at a rate 4 times faster than the conventional process

As such, it is clear that the invention provides several advantages over the prior art, including:
Efficient reaction leads to higher yield
Continuous flow operation
Volume of reactor reduced by 50 fold
No carbon dioxide compressor required

It will be appreciated by persons skilled in the art that the present invention may also include further additional modifications made to the system which does not affect the overall functioning of the system.

1. A method for sequestering carbon comprising the steps of:
spraying a solution containing calcium ions into a reactor containing supercritical carbon dioxide to form a slurry of calcium carbonate;
collecting the calcium carbonate from the bottom of the reactor.

2. The method according to claim 1 wherein the bottom section of the reactor includes an outlet provided with a back pressure regulator.

3. The method according to claim 1 wherein the regulator is adjusted such that the slurry continuously flows out of the reactor via the outlet while maintaining a predetermined height of slurry within the reactor.

4. The method according to claim 3 wherein the average particle size distribution of the calcium carbonate is varied by adjusting the back pressure regulator.

5. The method according to claim 2 wherein the height of the slurry is maintained at around 10% of the height of the reactor.

6. The method according to claim 1 wherein the solution comprises calcium hydroxide.

7. The method according to claim 6 wherein the solution comprises calcium oxide.

8. The method according to claim 1 wherein the solution is aqueous.

9. The method according to claim 1 wherein the supercritical carbon dioxide is provided in excess for the reaction with the calcium solution.

10. The method according to claim 1 wherein the solution is sprayed using an injector nozzle provided at the top section of the reactor, having a working pressure of around 80-400 bar.

11. A reactor for sequestering carbon comprising:
means for introducing supercritical carbon dioxide into a reaction chamber within the reactor;
an injector nozzle for spraying a solution containing calcium ions into the reaction chamber; and
an outlet with a back pressure regulator at the bottom of the reaction chamber;
wherein the regulator is adjustable such that a slurry can continuously flow out of the reactor via the outlet while maintaining a predetermined height of slurry within the reactor.

12. Calcium carbonate made according to claim 1.
